(19) United States
(12) Patent Application Publication
(10) Pub. No.: US 2011/0073045 A1
(43) Pub. Date: Mar. 31, 2011

(54) PET TOY INCLUDING TACTILE STIMULUS FOR EXCITEMENT AND EXERCISE OF A PET

(76) Inventor: ALBERT MOSES HAIM, Potomac, MD (US)

(21) Appl. No.: 12/571,370

(22) Filed: Sep. 30, 2009

(51) Int. Cl. A01K 29/00

(52) U.S. Cl. 119/707

(57) ABSTRACT

A pet toy, including a housing, and a vibration device coupled to an interior of the housing. The vibration device is configured to cause the housing to vibrate at a frequency that stimulates a pet, but is substantially inaudible to a human.

### BACKGROUND OF THE INVENTION

1. Field of the Invention

The present invention generally relates to a pet toy, and more particularly to a pet toy including a tactile stimulus mechanism for the excitation of pets.

2. Discussion of the Background

Traditionally, various types of devices related to toys for pets have been developed, in many shapes and sizes. Most previous attempts, although fulfilling their various objects, focus primarily on sonic stimulation, olfactory stimulation (e.g., as with catnip) or locomotion of the toy for the pet's excitement. Most of these toys can be a nuisance to the owner, with various noises being emitted from the various toys in the form of sound, and from the actual locomotion of the toy around a space. Devices that use locomotion, although used in confined spaces of apartments and condominiums, require a larger space to operate, and are not suitable for confined spaces. In addition, although these toys may cause excitement, they do not necessarily promote exercise for the pet.

### SUMMARY OF THE INVENTION

Therefore, there is a need for a pet toy that operates silently, and promotes excitement and exercise, which can be used in confined spaces, and does not cause a nuisance to the owner. The above and other needs are addressed by embodiments of the present invention, which provides a pet toy, for example, in the form of a plastic ball, sphere, block, and the like, including a tactile stimulus mechanism therein. Advantageously, the pet toy is configured to be compact and easy to play with, with the tactile stimulus mechanism being nearly silent in operation. In an exemplary embodiment, the pet toy includes a vibratory motor, and the like, as the stimulus mechanism, for providing tactile stimulation. The pet toy further includes a power source for overdriving the vibratory motor beyond a 3 v standard operating voltage, creating a higher vibrational frequency, for example, in the range of about 55 HZ to 220 Hz, and the like, and which is nearly silent to humans, and which optimally provides for a positive excitation reaction from the pet. The vibration frequency is transmitted to a housing of the pet toy, which can be of a rigid, but soft texture and which stimulates the pet's whiskers, tongue, nose, and the like. A potentiometer can further be included for controlling a range of frequencies of vibration. In a further exemplary embodiment, the tactile stimulus mechanism can include a piezoelectric vibration device, and the like, operating at the desired frequencies, and controlled by a potentiometer coupled to a microcontroller, and the like.

Accordingly, in an exemplary aspect there is provided a pet toy, including a housing, and a vibration device coupled to an interior of the housing. The vibration device is configured to cause the housing to vibrate at a frequency that stimulates a pet, but is substantially inaudible to a human.

Still other aspects, features, and advantages of the present invention are readily apparent from the following detailed description, simply by illustrating a number of exemplary embodiments and implementations, including the best mode contemplated for carrying out the present invention. The present invention is also capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings and in which like reference numerals refer to similar elements and in which:

FIG. 1 illustrates an exemplary pet toy with analog circuitry, according to an exemplary embodiment;

FIG. 2 illustrates an exemplary pet toy with digital circuitry, including a microcontroller, according to another exemplary embodiment; and

FIG. 3A-C illustrate exemplary shapes of a housing used for the pet toy of FIGS. 1-2.

### DETAILED DESCRIPTION OF THE PREFERRED EMBODIMENTS

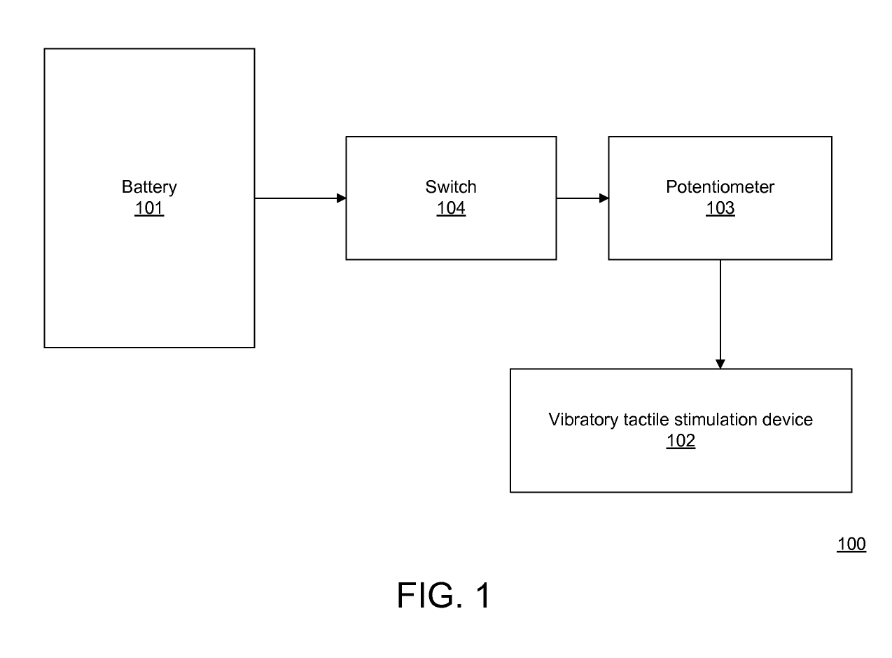

Referring now to the drawings, wherein like reference numerals designate identical or corresponding parts throughout the several views, and more particularly to FIG. 1 thereof, there is illustrated an exemplary pet toy 100 with analog circuitry, according to an exemplary embodiment. In FIG. 1, the pet toy includes a battery compartment 101 for holding a battery for powering the pet toy, a vibratory tactile stimulation device 102 (e.g., a vibrational motor, piezoelectric vibration device, etc.) for generating vibrations, a potentiometer 103 for controlling the voltage applied to the vibration device 102, and a switch 104 for turning on and off the pet toy.

The battery compartment 101 can reside in a portion of a housing of the pet toy (e.g., in one half of a ball-shaped, egg-shaped, square-shaped housing, etc.), and is configure to accommodate, for example, a compact 12V battery, and the like, such as an “N” size battery, and the like. The vibration device 102 can be configured as a coin shaped vibratory motor with a normal operating voltage of 3V, and the like, and with an internal eccentric weight, and the like. The vibration device 102 also can be configured as a piezoelectric vibration device, and the like. The vibration device 102 can operate in the range of 55 Hz to 220 Hz, for optimally exciting the pet's nose, tongue and whiskers, while advantageously being near silent to humans.

The potentiometer 103 is used to regulate the vibration frequencies and is located inside the pet toy housing, and can be operated when the casing is opened. The switch 104 can be a single pole-single toggle (SPST), pushbutton switch or a SPST slide switch, and the like, and can be placed in a location near the surface of the housing, for example, such that the housing and the switch 104 are flush, advantageously, preventing any accidental switching. In an exemplary embodiment, when the pet toy is switched on by the switch 104, the vibration device 102 can be configured to operate continuously.

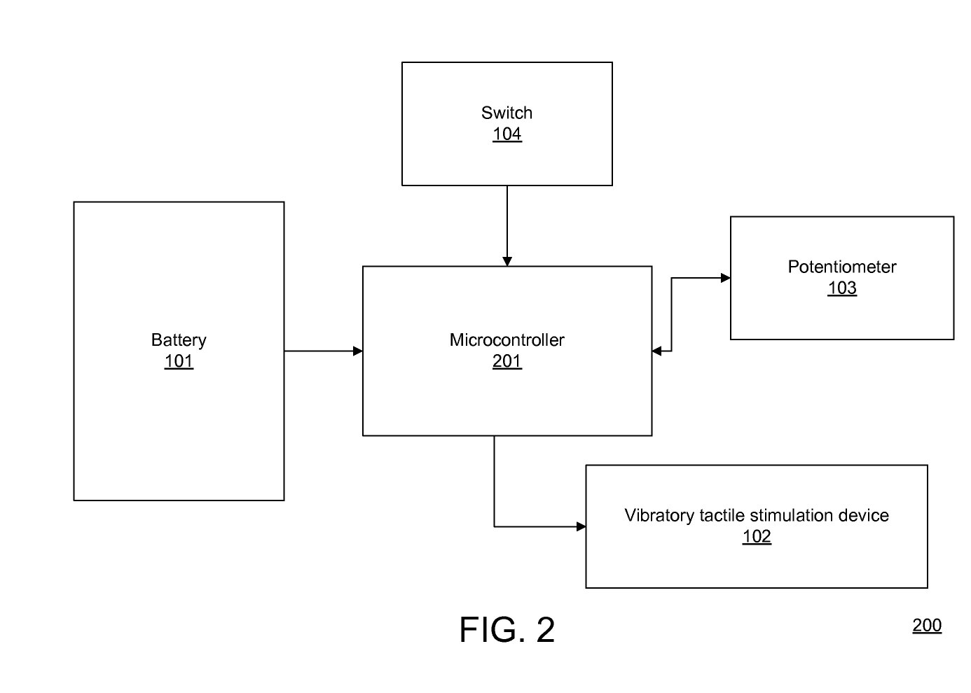

FIG. 2 illustrates an exemplary pet toy 200 with digital circuitry, including a microcontroller, according to another exemplary embodiment. The common components of the pet toy 200 of FIG. 2 operate in a similar manner as the corresponding components of the pet toy 100 FIG. 1. In FIG. 2, however, there is further included a microcontroller 201 (e.g., including a memory, etc.) configured to control different frequencies and wave functions, such as saw waves, square waves, sine waves, and the like, applied to the vibration device 102.

In an exemplary embodiment, the switch 104 is configured as a momentary SPST, pushbutton switch, which is configured to cycle through various states, such saw wave, square wave, sine wave, and the like, each time the switch 104 is pushed, wherein the various waves are cycled through continuously thereafter.

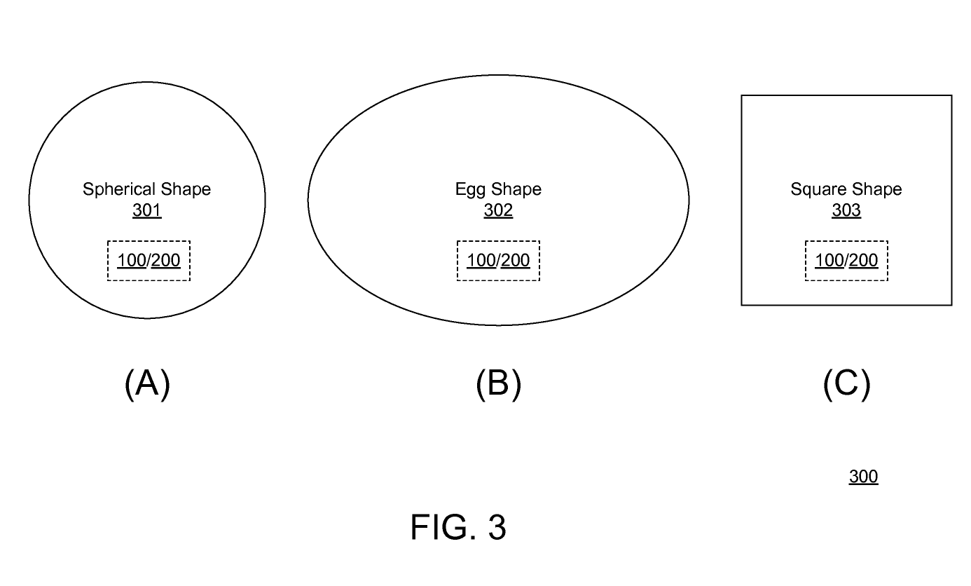

FIG. 3A-C illustrate exemplary shapes of a housing 300 used for the pet toys 100 and 200 of FIGS. 1-2. In FIG. 3A, the pet toy housing 300 can be configured in the shape of a spherical ball 301, which can be separated in two halves, via hinges, and attachment devices, and the like, to provide access to the circuitry of the pet toy 100 or 200. The spherical ball 301 can made of a rigid plastic, which has a soft texture, like the texture of a ping pong ball, and the like. Ideally, the diameter of the ball 301 is about 40 mm, but can be configured to any suitable size, depending on the pet. The ball 301 can be separated into two halves, for example, attached by miniature screws, and the like, or alternatively, can include latches on the interior so that the halves can be separated by a twisting motion, and the like.

In FIG. 3B, the pet toy housing 300 can be configured in the shape of an egg 302, but otherwise includes similar features as the pet toy housing 301. In FIG. 3C, the pet toy housing 300 can be configured in the shape of a square block 303, but likewise includes similar features as the pet toy housing 301. As will be appreciated by one of ordinary skill in the relevant art(s), the pet toy housing 300 can be configured in one of any suitable shapes.

The housing 300 of FIGS. 3A-C can be plastic injection molded, complete with the battery compartment 101, and configured to accommodate the circuitry of the pet toy 100 or 200. The vibration device 102 can be attached, for example, glued, and the like, to the housing 300 on an interior surface thereof for transmitting vibrational energy thereto. The potentiometer 103 also can be attached, for example, glued, and the like, to the interior of the housing 300, for access when the housing 300 is opened. The switch 104 also can be attached, for example, glued, and the like, to a compartment created by the injection molding for the switch 104, but should be flush with the surface of the housing 300, advantageously, such that accidental triggering is prevented.

While the present invention has been described in connection with a number of exemplary embodiments and implementations, the present invention is not so limited but rather covers various modifications and equivalent arrangements, which fall within the purview of the appended claims.

What is claimed is:

1. A pet toy, comprising:
a housing; and
a vibration device coupled to an interior of the housing,
wherein the vibration device is configured to cause the housing to vibrate at a frequency that stimulates a pet, but is substantially inaudible to a human.

2. The pet toy of claim 1, wherein the housing is in the shape of a sphere, an egg or a square block.

3. The pet toy of claim 1, wherein the vibration device comprises a vibratory motor or piezoelectric vibration device.

4. The pet toy of claim 3, further comprising a power source configured for overdriving the vibratory motor beyond a standard operating voltage thereof for creating a vibrational frequency in the range of about 55 HZ to 220 Hz.

5. The pet toy of claim 1, wherein the housing is made of a rigid plastic material.

4. The pet toy of claim 4, further comprising a potentiometer coupled between the power source and the vibration device for controlling a range of frequencies of vibration.

5. The pet toy of claim 1, further comprising a microcontroller coupled to the vibration device for controlling a wave form and a range of frequencies of vibration of the vibration device.

6. The pet toy of claim 5, wherein the wave form includes a square wave, a saw wave or a sine wave.
